(19) United States
(12) Patent Application Publication
(10) Pub. No.: US 2013/0045846 A1
(43) Pub. Date: Feb. 21, 2013

(54) Tool Holder

(71) Applicants: Franz ASCHENBRENNER, Gottingen (DE); Eberhard MAIER, Gottingen (DE); Uwe THIEME, Gottingen (DE)

(72) Inventors: Franz ASCHENBRENNER, Gottingen (DE); Eberhard MAIER, Gottingen (DE); Uwe THIEME, Gottingen (DE)

(73) Assignee: MIKSCH GMBH, Goppingen (DE)

(21) Appl. No.: 13/565,024

(22) Filed: Aug. 2, 2012

(30) Foreign Application Priority Data
Aug. 18, 2011 (DE) 102011081199.0

(51) Int. Cl. B23Q 1/03

(52) U.S. Cl. 483/59

(57) ABSTRACT

The invention relates to a tool holder for holding a tool (1) adapted to be inserted in a machine tool which includes a spindle head as tool head (11). The tool holder comprises a support (2) for supporting a tool (1) at the periphery thereof and a tool holding means (4) including a load-bearing member (42) which is adapted to engage in the supported tool (1) at one longitudinal end of the tool (1) at the tool head (11) or is capable of bearing a tool head outer peripheral area at the longitudinal end of the supported tool (1). The tool holding means (4) is movable in a direction facing away from the support (2) for lifting the engagement/support at the tool head (11).

### FIELD OF THE INVENTION

The present invention relates to a tool holder. More precisely, the present invention relates to a tool holder for holding a tool adapted to be inserted in a machine tool which has a tool holding fixture at one end.

In machine tools different tools are clamped which are stored in a magazine when not in use and are held in a tool holder there.

It is the object of the present invention to provide a novel advantageous tool holder for such tools.

This object is achieved by the novel tool holder comprising the features of claim 1.

Advantageous further developments are described in the dependent claims.

A tool holder line-up is shown in claim 16.

A tool holder comprising the features of claim 1 permits safe storing of a tool in a simple manner with a small number of components.

Typically, the tool is inserted in the machine tool by means of a tool holding fixture formed at the longitudinal end thereof.

The basic structure of tool holding fixtures frequently is very similar independently of the manufacturer due to the clamping device at the machine tool, because the outer shape of the tool holding fixture is defined by the fitting dimensions in the machine tool. In order to ensure a quick tool change while simultaneously guaranteeing high accuracy tool holding fixtures are standardized.

Hence, in the tool holder according to claim 1 the characteristic structure of the tool holding fixture is made use of in an advantageous manner for storing tools in a tool holder.

The tool holder according to claim 2 or 3 permits simple and quick removal of the tool stored. Thus the tool can be rapidly supplied to a machine tool.

The tool holder according to claim 4 to 8 or 11 permits to absorb the tilt moment of the supported tool with a small number of components.

The tool holder according to claim 9 or 10 prevents the supported tool 1 from being longitudinally displaced in a simple but safe manner.

The tool holder according to claim 12 permits facilitated insertion/removal of the tool into/from the tool holder, because the holding plate is movable away from the tool by a simple pressing movement at the inclined flange or by a simple pulling movement at the handle.

The tool holder according to claim 13 provides a compact structure, because the support rack 45 and the vertically upright projection 3 can be manufactured as one single component. The number of components is thus further reduced. Moreover, the tool load can be distributed to plural members of the tool holder by the load bearing capacity at the upper surface of the support rack 45.

The tool holder according to claim 14 further includes a bearing strip 50 on which the outer periphery of the tool holding fixture 11 can be supported. In the case of a possible dynamic pulse that temporarily relieves the tool, the tool holding fixture 11 can be prevented from “being hooked off”.

The tool holder according to claim 15 further includes at the tool holding means 4 on the side facing the support 2 a pressing means adapted to bear against the tool holding means 4 in order to bend/fold the tool holding means 4 away from the support 2, the pressing means acting above the load-bearing member 42.

Thus the tool holding means 4 can be operated in an automated manner which enables a tool to be deposited and taken up in a completely automated fashion.

The tool holder line-up according to claim 16 provides an inexpensive possibility of storing a plurality of tools.

On principle, the tool holder is designed so that a tool can be supported at two points (two areas). The main load of the tool is borne by the support 2 as first supporting point (supporting area), the support 2 being positioned in the tool holder at a position where it is closer to the point of gravity of the tool than the second supporting point. The second supporting point (supporting area) is formed at the end portion of the tool holding fixture opposed to the tool main body. The second supporting point can absorb the tilt moment of the tool supported by the first supporting point. The second supporting point forms a support adapted to be moved away toward the side facing away from the tool. During supporting, the load-bearing member 42 can insert or engage in the tool holding fixture as second supporting point and can constitute form-fit tilting moment absorption for the held tool. The tilting moment can be absorbed on the upper side and/or lower side of the load-bearing member 42. The load-bearing member 42 can act on the outer periphery and/or inner periphery of the front area (end area) of the tool holding fixture. If the tool is to be removed, the load-bearing member 42 can be laterally moved away from the tool until the load-bearing member 42 does no longer impede a removal of the tool to the top. A longitudinal displacement of the stored tool can be prevented by the longitudinal displacement prevention 3 adapted to engage in the tool. This longitudinal displacement prevention 3 can be a vertically upright projection and can engage at the periphery of the tool in the same. The longitudinal displacement prevention 3, the tool holding means 4 and the support 2 can be integrally formed or can be formed as separate components being seated on a base member (e.g. bottom plate) of the tool holder. Tools 1 having a point of gravity which is located behind the support 2 viewed in horizontal direction from the tool holding means 4 can be inserted in the tool holder. At the tool holding means 4 a pressing means such as a roller bending/folding the tool holding means 4 away from the support 2 can be made to bear against the side facing the support 2, the pressing means acting above the load-bearing member 42.

### BRIEF DESCRIPTION OF THE DRAWINGS

FIG. 1 illustrates a tool holder according to a first embodiment of the present invention including a tool in a perspective view.

FIG. 2 illustrates the tool holder of FIG. 1 in a sectional view.

FIG. 3 illustrates a tool holder according to a modification of the fifth embodiment of the present invention.

FIG. 4 shows alternatives of a tool holder of the present invention.

### DETAILED DESCRIPTION OF AN EMBODIMENT

Hereinafter the present invention will be illustrated in detail by way of embodiments.

### First Embodiment

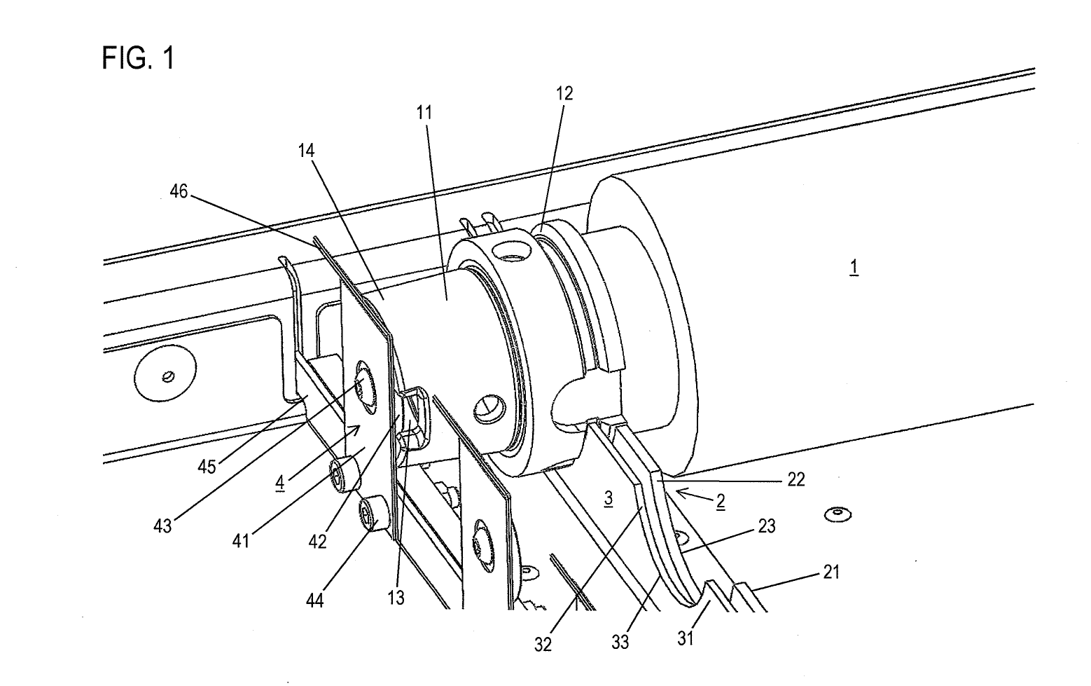

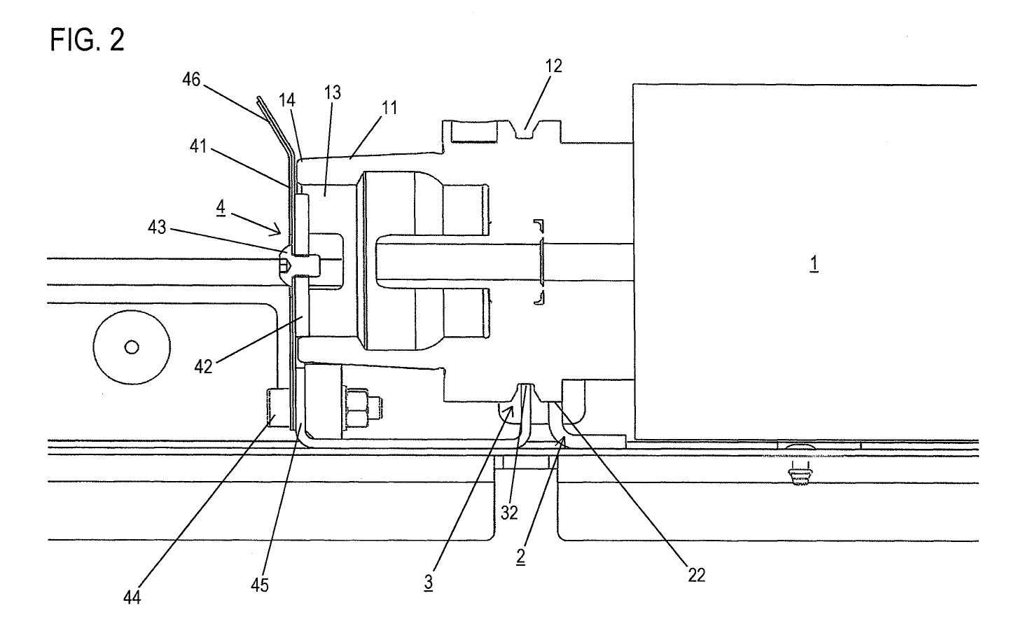

FIG. 1 shows a tool holder according to a first embodiment of the present invention including a tool in a perspective view. FIG. 2 illustrates the sectional view thereof (in longitudinal section). The tool to be held in the tool holder according to the invention is a tool, for instance, which is adapted to be inserted in a machine tool. Tools of this type have a plurality of functions and consequently very different designs but are usually equipped with a similar tool holding fixture with which the tool is inserted in the machine tool. The tool 1 of the present embodiment includes such tool holding fixture 11 as shown in FIG. 1. Typically, such tools 1 are also equipped with a groove 12 extending at the outer periphery of the tool 1 as gripper notch. In the present example such groove 12 is formed at the outer periphery of the tool holding fixture 11 in an area that is close to the main body of the tool 1.

The tool holder of the present embodiment consists of a support 2, a longitudinal displacement prevention (engaging projection) 3 and a tool holding means 4. The support 2, the longitudinal displacement prevention 3 and the tool holding means 4 are mounted on a bottom plate.

The support 2 is in the form of a wall 21 having a recess 23 which in the present example has a semicircular concave shape at its upper side, i.e. opposed to the bottom plate. In the recess 23 the upper side serves as bearing face 22, wherein it extends horizontally in the direction of the longitudinal axis of the tool to be borne. The bearing face 22 is formed so that it extends concentrically with respect to a tool axis of the tool to be borne.

The longitudinal displacement prevention 3 constitutes an engaging projection 3 and in this embodiment is equally designed as a wall 31 having on its upper side a concave recess 33, wherein in the recess 33 the upper surface of the wall 31 has a bearing face 32 that may extend horizontally in axial direction of the tool to be inserted. In the present embodiment the wall 31 of the engaging projection 3 is thus structured similarly to the wall 21 of the support 2. The wall 31 and the wall 21 extend in parallel to each other.

The tool holding means 4 in the present embodiment is primarily formed by an elastic holding plate 41 consisting of elastic, i.e. flexible material. The holding plate 41 is fastened to a support rack 45 on its lower side by means of fastening means 44 (screws, rivets etc.) so that the holding plate 41 is mounted vertically upwards. In the central area of the holding plate 41 of rectangular shape a load-bearing member 42 is fastened to the holding plate 41 via fastening means 43 (screw, rivet etc.). In the present embodiment the load-bearing member is a tool holding engagement means 42 and is disk-shaped. On the upper side of the holding plate 41, i.e. on the side opposed to the fastening means 43, a flange 46 has an angular design so that it is inclined away from the support 2 as shown in FIG. 1.

The tool holding means 4 is spaced in horizontal direction from the support 2 so far that a tool 1 can be inserted in the tool holder so that the tool holding fixture 11 of the tool 1 bears at its end face against the holding plate 41 and its peripheral surface bears on the support 2 in an area adjacent to the tool main body.

The tool 1 is deposited on the support so that the bearing face 22 supports the tool 1. In the present example the point of gravity of the tool 1 is located on the right of the support 2 in FIG. 1. In order to avoid tilting of the tool 1 in the direction pointing to the right bottom in the drawing due to the dead weight of the tool, the tool 1 is supported so that the tool holding engagement means 42, viz. the disk, is inserted in the centric recess 13 at the tool holding fixture 11. Thus, the outer surface of the disk of the tool holding engagement means 42 bears against the wall 14, more precisely against a lower area of the inner wall of the centric recess 13 at the tool holding fixture 11, as shown in FIG. 2. A tilting moment of the tool 1 therefore is transmitted through the wall 14 to the disk of the tool holding engagement means 42. Hence the tool 1 is prevented from tilting.

In a modification of the embodiment the tool holder can also be designed and dimensioned so that in addition a lower outer surface of the wall 14 of the tool holding fixture 11 bears on an upper surface of the support rack 45, cf. FIG. 2. However, for bearing the tool 1 it is sufficient already that the tool 1 bears on the bearing face 22 and with the inside of the wall 14 bears against the lower outer surface of the tool holding engagement means 42.

If the tool 1 is to be removed from the tool holder, the tool 1 is grasped at its main body and the tool holding means 4, i.e. the holding plate 41, is bent away from the tool 1 at the flange 46. Since the holding plate 41 is made of elastic material and is manufactured to have a thickness suited for this bending process, the holding plate 41 is quasi resilient and can easily be bent away from the tool 1. When bending the holding plate 41 away, the disk-shaped tool holding engagement means 42 moves out of the centric recess 13 at the tool holding fixture 11 and releases the tool holding fixture 11. Now the tool can be removed.

The flange 46 facilitates bending the holding plate 41 away without being an obstacle during insertion of the tool 1, because the tool holder is easily accessible from the top due to the inclined arrangement of the flange 46.

The material of the holding plate 41 can be spring steel, but can also be employed any other material having sufficient stability as a holding plate and exhibiting a resilient or elastic effect that permits outwardly directed bending of the holding plate.

Advantageously the support rack 45 and the wall 31 of the engaging projection 3 are interconnected and manufactured as one single component, as is shown in FIG. 2. Alternatively, both elements may also be separate components.

The horizontal surface of the wall 31 in the recess 33 advantageously is a bearing face 32 on which the bottom of the groove 12 of the tool 1 bears. However, the surface 32 can also be spaced from the bottom of the groove 12 when the tool 1 is deposited, the tool 1 bearing on the bearing face 22.

In the tool holder tools 1 having a point of gravity which is located behind the support 2 viewed in horizontal direction from the tool holding means 4 are adapted to be inserted.

### Second Embodiment

In the first embodiment the engaging projection 3 is in the form of a wall 31. This wall 31 engages in the groove 12 of the tool 1, when the tool 1 is supported on the bearing face 22 of the support 2. In the present embodiment not illustrated in the drawings this engaging projection 3 is formed by a pin extending approximately vertically which is fastened to the bottom plate with or without an intermediate member and which has such length that, when the tool is supported on the bearing face 22, it protrudes from below into the groove 12. The upper portion of said pin protruding into the groove 12 of the tool 1 prevents the tool 1 from being displaced in the longitudinal direction while the tool is supported. Instead of one pin, also a plurality of such pins can be employed the upper portions of which protrude into the groove 12 at the tool 1 while the tool is supported.

The upper face of the pin of the engaging projection 3 can also be formed so that the pin does not only protrude into the groove 12 at the tool 1 but extends to a such height, while the tool 1 is supported on the bearing face 22 of the support 2, that the upper surface of the pin equally serves as bearing face. In this case the function of the bearing face is performed for supporting the weight of the tool 1 not only by the bearing face 22 of the support 2 but also by the bearing face (end face) 32 of the pin of the engaging projection 3.

The pin of the engaging projection 3 need not absolutely be placed vertically on the bottom plate. It can also be arranged at angles with respect to the bottom plate so that it protrudes tangentially into the groove (gripper notch) 12 of a deposited tool.

Furthermore, two inclined pins having the form of an inverted V may be arranged on the bottom plate so that the area in which the pins converge as legs of said V constitutes the upper side of the engaging projection.

Alternatively, the engaging projection 3 can also be formed by a wall portion of the wall 31. In this case the wall 31 does not extend along the entire groove 12 of the tool 1 but only in a portion of the groove 12. Such wall can be formed by a rectangular plate that is mounted vertically and whose upper end face is adapted to the contour of the engaging groove 12.

### Third Embodiment

In the first embodiment the holding plate 41 of the tool holding engagement means 4 is designed as an elastic and flexible plate. In the present third embodiment not illustrated in the drawings the tool holding means 4 includes, instead of the flexible holding plate 41, a plate that is hinged to the support rack 45 via a joint (e.g. hinge). This joint can be locked e.g. by means of a detent pin or in any other way, the holding plate being vertically located in the locked state of the holding plate. When the tool is to be removed from the tool holder, the joint is unlocked and the holding plate is folded away from the tool 1 around the joint. The holding plate pivoting at the joint can be biased toward the tool, i.e. toward the support 2, by means of a spring.

### Fourth Embodiment

In the first embodiment the tool holding engagement means 42 is disk-shaped. Said disk engages in the centric recess 13 at the tool holding fixture 11, the outer wall of the disk of the tool holding engagement means 42 bearing with the inner surface of the wall 14 against the tool holding fixture 11. In the lower area of the disk of the tool holding engagement means 42 the tilting moment is transmitted when the tool 1 has a point of gravity which is located behind the support 2 viewed in the horizontal direction from the tool holding means 4.

In the present embodiment which is not shown in the drawings the function of the transmission of the tilting moment is not performed by a disk but by a member which merely bears against the inner surface of the lower area of the wall 14 while the tool 1 is supported. Such member can be kind of a semi-disk fastened to the holding plate 41 by fastening screws 43 and extending merely downwards so that the inner surface of the wall 14 bears against the lower edge of said semi-disk when the tool 1 is supported. The tool holding engagement means of the first embodiment and the semi-disk are adapted to the contour of the inner surface of the wall 14. In a further alternative the tool holding engagement means 42 can be configured so that it protrudes downwards from the fastening point pin-like as round pin or as square while being fastened to the holding plate 41 by the fastening means 43, wherein the end face of said pin facing the bottom bears against the inner surface of the wall of the tool holding fixture 11, while the tool 1 is supported, and absorbs the tilting moment which is transmitted from the tool 1 to the holding plate 41. Said end face is preferably rounded such that it is matches the contour of the inner surface of the wall 4 of the recess 13 at the tool holding fixture 11.

### Fifth Embodiment

In the first embodiment the tool holding engagement means 42 engages as a disk in the centric recess 13 at the tool holding fixture 11. In the basic form of the present embodiment not shown in the drawings the tool holding engagement means encompasses the tool holding fixture 11 from outside. Hence, in the present embodiment the tool holding engagement means is formed as a ring whose inner diameter is sized so that the outer surface of the tool holding fixture 11, i.e. the outer surface of the wall 14 is inserted in the ring, while the tool 1 is supported. The ring is fastened to the holding plate 41 of the tool holding fixture 4. Thus, the inner surface of the ring absorbs the tilting moment of the tool 1 through the outer surface of the wall 14 at the tool holding fixture 11.

As an alternative, this tool holding engagement means of the fifth embodiment can also be configured so that it forms no complete ring which outwardly surrounds the wall 14 of the tool holding fixture 11, but can be a ring portion which merely surrounds the upper side of the wall 14 of the tool holding fixture 11, while the tool 1 is supported. Said ring portion matches, at its inner surface, i.e. the surface pointing toward the bottom, the contour of the wall 14 of the tool holding fixture 11 and absorbs the tilting moment, while the tool 1 is supported.

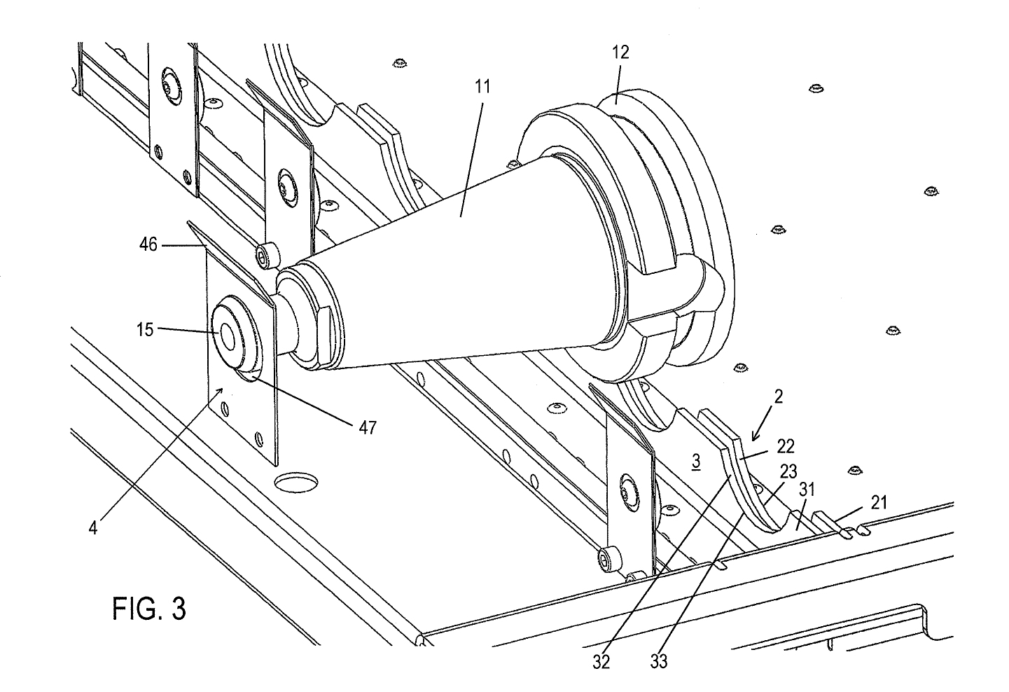

FIG. 3 illustrates a tool holder according to a modification of the fifth embodiment of the present invention. In this modification a draw-in bolt 15 is provided at the end of the tool holding fixture 11. The holding plate of the tool holding means 4 includes a centric opening 47 through which the draw-in bolt 15 is introduced upon depositing the tool. In the deposited position, the upper side of the draw-in bolt 15 bears against the upper inner periphery of the opening 47. The upper inner periphery of the opening 47 then absorbs the tilting moment of the tool.

In an alternative to the modification of FIG. 3, the opening 47 is sized so that the tool holding fixture 11 can be inserted in the opening 47. The distance between the longitudinal displacement prevention 3 and the holding plate of the tool holding means 4 is selected so that the upper inner periphery of the opening 47 then absorbs the tilting moment of the tool through the upper side of the tool holding fixture 11.

In the foregoing, the present invention has been described by way of embodiments.

Further embodiments are imaginable. For example, when it is little likely that a longitudinal displacement of the supported tool 1 occurs, the engaging projection 3 can be completely omitted so that the tool holder consists merely of the support 2 and the tool holding means 4.

The flange 46 facilitates the pivoting operation of the holding plate 41 of the tool holding means 4 when removing the tool 1. Instead of the flange 46 which, as shown in the first embodiment and in the drawing, is configured to be inclined outwardly, i.e. away from the tool 1, a handle can be formed at the holding plate 41 on the side facing away from the support 2. By means of the handle the holding plate 41 can then be bent or pivoted away from the tool.

The flange 46 of the first embodiment can also be omitted. Then the holding plate 41 is merely formed as vertical upright holding plate 41. This provides simple and thus inexpensive manufacture of the tool holder.

In a further configuration of the invention a pressing means can be provided at the holding plate 41 on the side facing the support 2. The pressing means can be made to contact the holding plate 41 and can bend or fold the holding plate 41 in the direction facing away from the support 2. The pressing means preferably acts above the load-bearing member 42 and thus above the tool to be deposited.

The pressing means can consist of a roller which is supported on a shaft and is movable toward the holding plate 41 and away from the holding plate 41 by a movable supporting arm. Due to the pivoting movement of the roller guided by way of the supporting arm the roller presses against the holding plate 41 and inclines the holding plate 41 in the direction facing away from the support 2 so as to insert or remove a tool. In a simplified variant the pressing means can be formed of a hook. The pressing means can be applied especially when the holding plate 41 is configured merely as a vertical upright holding plate 41 made of spring steel.

By applying the pressing means the tool holder can be operated in an automated fashion, thus permitting a completely automated depositing and taking up of a tool while the holding plate 41 tilts in an automated fashion.

With an application of the tool holder, plural tool holders are configured to be adjacent to each other as a tool holder line-up as is shown in FIG. 1. The support 2 is an oblong square-type wall body having a vertically upright form and including the recesses 23 for holding the tool at dedicated intervals. The interval from one recess 23 to the next recess 23 results from the size of the tools 1 to be supported. In a corresponding manner, the holding plates 41 for absorbing the respective tilting moment of the supported tool 1 are arranged at the support rack 45 while being associated with the recesses 23 of the support 2. That is to say, plural holding plates 41 are fastened to a support rack 45 along the longitudinal direction thereof by the fastening means 44 (screws).

The load-bearing member 42 can be fastened to the holding plate 41 in a removable (detachable) or permanent (e.g. welded) manner. By exchanging the load-bearing member 42 in different sizes at the holding plate 41, the same depositing place can be used for various tools having different respective tool holding fixtures by a simple conversion. The previous load-bearing member 42 is dismounted and replaced with a load-bearing member 42 that matches the tool holding fixture of the new tool to be borne.

In another alternative, the tool holder is designed so that an upper portion of the inner surface of the wall 14 can bear at the recess 13 of the tool holding fixture 11 against the upper outer surface of the load-bearing member 42 or, in the case of a load-bearing member 42 supporting at the outer periphery of the wall 14 of the tool holding fixture 11, a lower portion of the outer surface of the wall 14 can bear against an upwards facing surface (e.g. inner ring side) of the load-bearing member 42.

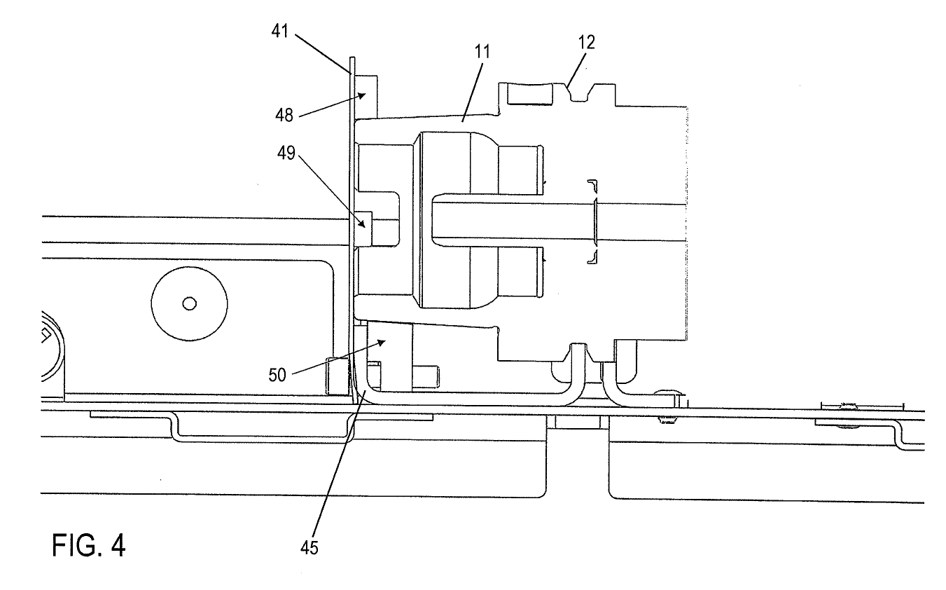

FIG. 4 illustrates further alternatives of a tool holder of the present invention.

In another alternative, the tool holding engagement means is merely designed as a catch 48 as support of the upper side which protrudes from the holding plate 41 of the tool holding means to the side of the support 2 and is arranged at such height at the holding plate 41 that, while the tool 1 is supported, it bears against the outer surface of the wall 14 of the tool holding fixture 11 at the then upper area of the tool holding fixture 11. Then said catch 48 is adapted to absorb the tilting moment of the supported tool 1. The catch 48 can be in the form of a pin, cylinder, square or the like.

Instead of said catch, a mold part 48 can be mounted to the holding plate as support of the upper side on the side facing the longitudinal displacement prevention 3. The lower side of the mold part 48 exhibits a shape that matches the outer periphery of the tool holding fixture 11, i.e. the contour of the tool holding fixture 11. In the deposited position, the upper side of the tool holding fixture 11 bears against the lower side of the mold part 48. The lower side of the mold part 48 then absorbs the tilting moment of the tool.

In FIG. 4 the reference numeral 49 denotes a cross-member mounted at the holding plate on the side facing the longitudinal displacement prevention 3. Preferably, the bearing strip 50 is fastened to the holding plate by the fastening means 44, but it can also be fastened by a fastening means that is separate from the fastening means 44. The bearing strip 50 includes an upper surface on which the outer periphery of the tool holding fixture 11 can be deposited. The upper surface can match the outer periphery of the tool holding fixture 11. As an alternative, the upper surface of the bearing strip 50 can be an obliquely extending surface having a height decreasing toward the longitudinal displacement prevention 3 (cf. FIG. 4) or a horizontally extending surface. The bearing strip 50 serves for preventing the tool holding fixture 11 from being “hooked off” in the case of a possible dynamic pulse that temporarily relieves the tool (e.g. during transport when passing a step). The bearing strip 50 need not be fastened to the holding plate but can as well be arranged at a distance from the holding plate. The bearing strip 50 can be added to each of the afore-illustrated embodiments or alternatives.

Although the tool holder according to the invention is intended for tools that are inserted in machine tools and therefore include the characteristic and standardized tool holding fixture, the tool holder can also be applied to other tools.

Combinations of the afore-described embodiments are imaginable.

### LIST OF REFERENCE NUMERALS

1 Tool
11 tool holding fixture
12 groove
13 recess at the tool holding fixture
14 wall
15 draw-in bolt
2 support
21 bearing face
23 recess
3 longitudinal displacement prevention, engaging projection
31 wall
32 bearing face
33 recess
4 tool holding means
41 holding plate
42 load-bearing member, tool holding engagement means
43 fastening means
44 fastening means
45 support rack
46 flange
47 opening
48 support of the upper side at the holding plate
49 cross-member at the holding plate
50 bearing strip

1. A tool holder for holding a tool adapted to be inserted in a machine tool which includes a tool holding fixture at its end, the tool holder comprising:
a support for supporting a tool at the periphery thereof,
a tool holding means including a load-bearing member which is adapted to engage in the supported tool at a longitudinal end of the tool at the tool holding fixture or is capable of bearing an outer peripheral area of the tool holding fixture at the longitudinal end of the supported tool;
wherein the tool holding means is movable in a direction facing away from the support for lifting the engagement/support at the tool holding fixture.

2. The tool holder according to claim 1, wherein
the tool holding means is made of elastic material and is bendable in the direction facing away from the support for lifting the engagement/support at the tool holding fixture.

3. The tool holder according to claim 1, wherein
the tool holding means includes a lockable joint and is foldable in the direction facing away from the support for lifting the engagement/support at the tool holding fixture when the joint is unlocked.

4. The tool holder according to claim 1, wherein
at the tool holding means a tool holding engagement means is arranged as load-bearing member on the side facing the support for positively holding one end of the tool holding fixture while the tool is supported.

5. The tool holder according to claim 4, wherein
the tool holding engagement means is a projection movable into a recess provided at the tool holding fixture.

6. The tool holder according to claim 5, wherein
the projection is a disk, a disk sector or a pin and is adapted to bear at least at the lower central area against the inside of a recessed wall at the tool end.

7. The tool holder according to claim 4, wherein
the tool holding engagement means is a projection which is adapted to bear against the outer peripheral side of the tool holding fixture.

8. The tool holder according to claim 7, wherein
the tool holding engagement means is a ring, a ring portion or a pin and is adapted to bear at least in the central area against the upper side of the outer peripheral side of the tool holding fixture.

9. The tool holder according to claim 8, wherein
the tool holder includes a longitudinal displacement prevention to which a recess of the tool can be attached at the outer peripheral surface thereof.

10. The tool holder according to claim 9, wherein
the longitudinal displacement prevention as vertically upright projection forms one or more pins, a wall or a wall portion adapted to be inserted in a peripheral groove as a recess at the outer peripheral surface of the tool, the vertically upright projection dimensionally matching the groove of the tool.

11. The tool holder according to claim 1, wherein
the tool holding means includes a vertically arranged holding plate as contact surface for the end face of the tool holding fixture, the holding plate being fastened to a support rack.

12. The tool holder according to claim 11, wherein
the vertically arranged holding plate includes a flange directed obliquely upwards away from the support and/or a handle arranged on the side of the vertically arranged holding plate facing away from the support for lifting the engagement/support at the tool holding fixture.

13. The tool holder according to claim 11, wherein
the support rack is connected to the vertically upright projection and/or an upper surface of the support rack forms a depositing surface for the tool holding fixture.

14. The tool holder according to claim 1, wherein
the tool holder further includes a bearing strip on which the outer periphery of the tool holding fixture can be supported.

15. The tool holder according to claim 1, wherein
a pressing means that bends/folds the tool holding means away from the support can be made to bear against the tool holding means on the side facing the support, the pressing means acting above the load-bearing member.

16. A tool holder line-up comprising
plural tool holders according to claim 1 which are arranged in line.
